(19) United States
(12) Patent Application Publication
(10) Pub. No.: US 2005/0211106 A1
(43) Pub. Date: Sep. 29, 2005

(54) Cooking pan

(75) Inventor: Lothar Dierkes, Meerbusch (DE)

Correspondence Address: ROBERT W. BECKER & ASSOCIATES, Suite B, 707 Highway 66 East, Tijeras, NM, 87059, US

(73) Assignee: QVC Handel GmbH, Dusseldorf (DE)

(21) Appl. No.: 11/091,268

(22) Filed: Mar. 28, 2005

(30) Foreign Application Priority Data
Mar. 28, 2004 (DE) 10 2004 015 511.9

(51) Int. Cl. A47J 37/10

(52) U.S. Cl. 99/422

(57) ABSTRACT

A cooking pan, in particular a griddle pan, with a pan bottom having a stove side and a food side, with a surrounding side wall arranged on an outer edge of the pan bottom and having an upper edge. Ribs are provided on the food side and have grooves formed between the ribs. The food side forms an acute angle with the stove side.

The instant application should be granted the priority date of Mar. 28, 2004, the filing date of the corresponding German patent application 10 2004 015 511.9.

### BACKGROUND OF THE INVENTION

The present invention relates to a pan for the preparation of food.

A pan is known from U.S. Pat. No. 5,967,024, wherein the food side of the pan bottom is substantially smooth and has a spiral-shaped groove opening into a reservoir formed at the edge of the pan bottom. The fat that is released during the cooking process and the meat juice are thereby drained into the reservoir. The intention is for the food that is to be cooked to itself be kept free of fat in this way. In practice, this has only limited success.

Furthermore, so-called griddle pans are known having ribs on the food side. The food to be cooked lies on the ribs. The fat and the meat juice collect in the grooves lying between the ribs. The liquid thereby remains partly under to food to be cooked and affects the quality of the food to be cooked by, for example, the development of steam. The liquid cannot be advantageously drained.

It is therefore the object of the present invention to produce a cooking pan, wherein the removal of the liquid produced is guaranteed to be more efficient.

This object is achieved by a pan, especially a griddle pan, having a pan bottom with a stove side and a food side, wherein a side wall extends about an outer edge of the pan bottom and has an upper edge; the food side is provided with ribs, with grooves being formed between the ribs, wherein the food side forms an acute angle with the stove side. At least one handle is connected to the side wall.

Advantageous configurations result from the features described subsequently.

In the following, an embodiment of the present invention is described by reference to the drawing, in which:

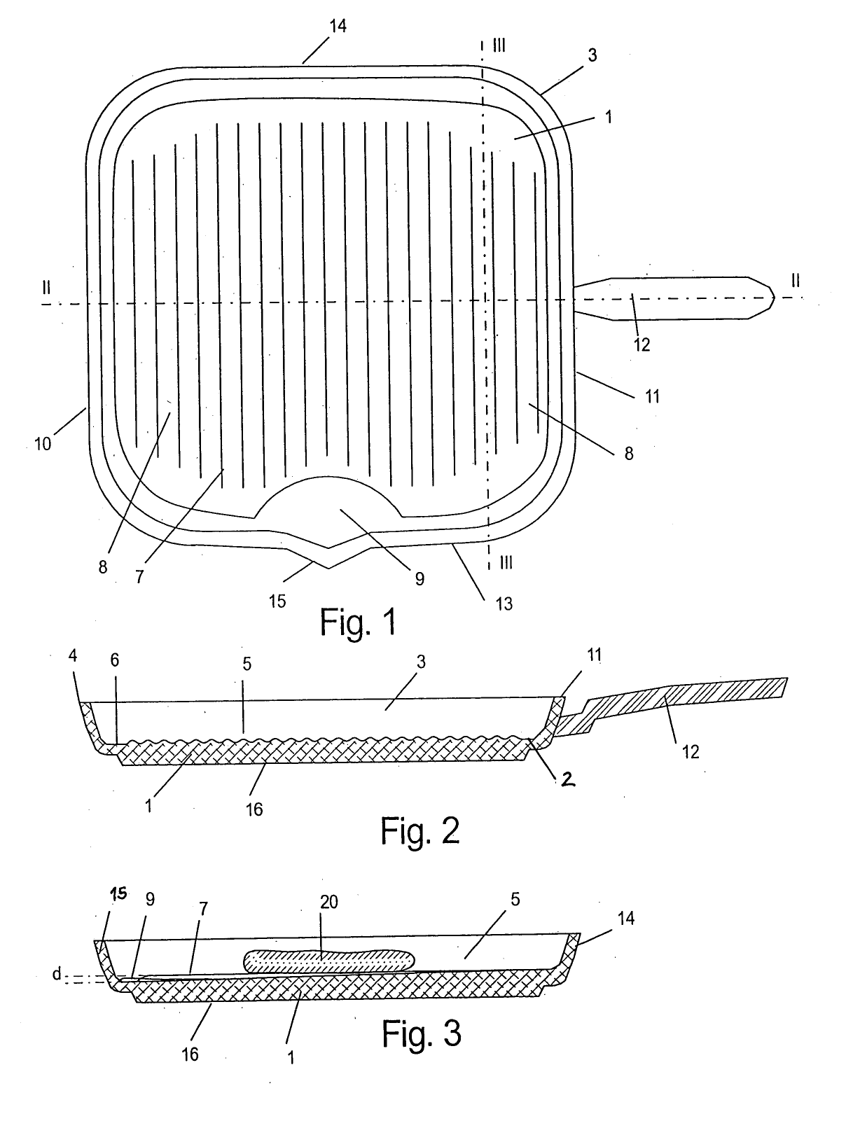

FIG. 1 is a plan view of a cooking pan in accordance with the invention;

FIG. 2 is a cross-section through the pan of FIG. 1 taken transverse to the groove structure; and

FIG. 3 is a cross-section through the pan of FIG. 1 parallel to the rib structure.

FIG. 1 illustrates a griddle pan in accordance with the invention in a plan view. A pan bottom 1 is formed approximately square with cushion-shaped edges 2 rounded outwards. At the edges 2 the pan bottom 1 has a surrounding side wall 3 with an upper edge 4. The pan bottom 1 determines with the side wall 3 a cooking space 5 opening upwards. The surface of the pan bottom 1 turned towards the cooking space forms a food side 6, having a number of ribs 7. Between every two adjacent ribs 7 is a groove 8. Alongside the ribs 7 and grooves 8 a trough-shaped reservoir 9 is provided. The ribs 7 extend parallel to one another and approximately parallel to the two adjacent side wall sections 10, 11. A handle 12 is attached at the middle of the side wall section 11.

Two side wall sections 13 and 14 join the side wall sections 10 and 11 to each other. The side wall section 13 has centrally on its upper edge 4 a v-shaped bulge 15 forming a spout.

FIG. 2 illustrates a cross-section through the pan of FIG. 1 along the line II-II transverse to the ribs 7. The side wall 3 extends away from the pan bottom 1 in a conical shape. The lower stove side 16 turned away from the food side 6 of the pan bottom 1 during use is flat. The stove side 16 is aligned parallel to the upper edge 4.

Finally, FIG. 3 shows a cross-section through the pan of FIG. 1 along the line III-III parallel to the ribs 7.

The upper side of the ribs 7 is formed parallel to the stove side 16. The food side 6 is angled between the ribs 7, so that if forms an acute angle of approximately 1° with the stove side 16. The difference in thickness of the pan bottom 1 form the side wall section 14 to the side wall section 13 is referenced by d and amounts to approximately 5 mm for a pan size of 28 cm.

During use, the pan stands on a cooking surface of a horizontally aligned stove. The food 20 to be cooked lies on the ribs 7. The oven side 16 and the ribs are aligned parallel to the cooking surface and are horizontal during use. The food side also has grooves 8 which, in use, are inclined to the horizontal at the acute angle described. Due to this inclination, fat and juice can escape from the food 20 to be cooked and run along the grooves 8 to the reservoir 9. The food 20 to be cooked is therefore not impacted by these liquids and with the developing steam during preparation. The food 20 to be cooked is thereby advantageously prepared as regards and consistency. Moreover, the liquid in the reservoir 9 can be poured off quickly and effectively. The draining off of the liquid from the area of the food 20 to be cooked takes place more quickly and effectively than in known cooking pans.

The specification incorporates by reference the disclosure of German priority document 10 2004 015 511.9 filed Mar. 28, 2004.

The present invention is, of course, in no way restricted to the specific disclosure of the specification and drawings, but also encompasses any modifications within the scope of the appended claims.

1. A cooking pan, comprising:
a pan bottom having a stove side and a food side,
wherein a side wall extends about an outer edge of said pan bottom,
wherein said side wall has an upper edge, wherein said food side is provided with ribs, wherein grooves are formed between said ribs, and
wherein said food side forms an acute angle with said stove side; and at least one handle connected to said side wall.

2. A cooking pan according to claim 1, wherein said food side is inclined by an angle of 0.5 to 5° relative to said stove side.

3. A cooking pan according to claim 2, wherein said inclination is provided parallel to said ribs.

4. A cooking pan according to claim 1, wherein said ribs have an upper side that faces away from said pan bottom and extends parallel to said stove side.

5. A cooking pan according to claim 1, wherein said pan bottom has the shape of a right-angled quadrilateral with rounded corners, wherein said ribs and grooves extend essentially parallel to two side wall sections of said side wall.

6. A cooking pan according to claim 1, wherein said grooves, at an end that is closest to said stove side, open into a reservoir.

7. A cooking pan according to claim 1, wherein said at least one handle is disposed on a side wall section of said side wall that extends parallel to said ribs.
